(19) United States
(12) Patent Application Publication
(10) Pub. No.: US 2018/0024689 A1
(43) Pub. Date: Jan. 25, 2018

(54) LIGHT-TRANSMITTING CONDUCTIVE MATERIAL

(71) Applicant: MITSUBISHI PAPER MILLS LIMITED, Tokyo (JP)

(72) Inventor: Takenobu Yoshiki, Tokyo (JP)

(73) Assignee: MITSUBISHI PAPER MILLS LIMITED, Tokyo (JP)

(21) Appl. No.: 15/714,139

(22) Filed: Sep. 25, 2017

Related U.S. Application Data
(63) Continuation of application No. PCT/JP2016/058689, filed on Mar. 18, 2016.

(30) Foreign Application Priority Data
Mar. 26, 2015 (JP) 2015-064379

(51) Int. Cl. G06F 3/041; G06F 3/044; G06F 3/047; H01B 5/14

(52) U.S. Cl. CPC G06F 3/0416; H01B 5/14; G06F 3/044; G06F 3/047; G06F 2203/04112

(57) ABSTRACT

An optically transparent conductive material including an optically transparent support; and a pattern of metal thin wires of repeated unit figures formed on the optically transparent support, wherein the unit figure is a combination of a main cell and a satellite cell, the number of cells sharing a side and/or a vertex with and adjacent to the main cell is larger than the number of cells sharing a side and/or a vertex with and adjacent to the satellite cell, and the longest distance between two arbitrarily selected points on the metal thin wires forming the main cell is longer than the width of the main cell in a direction perpendicular to the direction between the two points.

### TECHNICAL FIELD

The present invention relates to an optically transparent conductive material for touchscreens, organic EL materials, solar cells, and the like. More specifically, the present invention relates to an optically transparent conductive material suitable for projected capacitive touchscreens, particularly suitable for single-layer capacitive touchscreens.

### BACKGROUND

Touchscreens are widely used as input means on displays of smart devices such as personal digital assistants (PDAs), laptop computers, smartphones, and tablet computers, and other electronic devices such as office automation equipment, medical equipment, and car navigation systems.

There are a variety of touchscreens that utilize different position detection methods, such as optical, ultrasonic, resistive, surface capacitive, and projected capacitive touchscreens. A resistive touchscreen includes an optically transparent conductive material and a glass plate with an optically transparent conductive layer, which face each other with a spacer therebetween. An electrical current is applied to the optically transparent conductive material, and the voltage of the glass plate with an optically transparent conductive layer is measured. In contrast, a capacitive touchscreen basically includes an optically transparent support and an optically transparent conductive layer thereon. Since the capacitive touchscreen does not include movable parts, it has high durability and high optical transparency. Thus, such capacitive touchscreens are used in various applications. In particular, projected capacitive touchscreens capable of simultaneous multipoint detection are widely used in devices such as smartphones and tablet PCs.

Conventional transparent electrodes (optically transparent conductive materials) for touchscreens are usually those including an ITO (indium-tin oxide) conductive film as an optically transparent conductive layer formed on an optically transparent support. Yet, ITO conductive films have high refractive index and thus have high surface reflectivity, so that optically transparent conductive materials including an ITO conductive film unfortunately have a low total light transmittance. In addition, due to low flexibility, such ITO conductive films are prone to crack when bent, resulting in an increased electrical resistance.

As an alternative optically transparent conductive material including an optically transparent conductive layer that is not an ITO conductive film, a metal mesh material including an optically transparent support and a net-like pattern of metal thin wires thereon has been drawing attention. As a method for producing such a metal mesh material, the following methods have been proposed, for example: a semi-additive method in which a thin catalytic layer is formed on a support having a base metal film, a pattern is formed thereon using a resist, a metal layer is stacked on a resist opening portion by plating, and lastly, the resist layer and the base metal protected by the resist layer are removed, thus forming a net-like pattern of metal thin wires; a silver salt photographing method that employs a silver halide photosensitive material; and a silver salt diffusion transfer method.

A metal mesh material produced by any of these methods has various advantages. For example, it can exhibit higher conductivity and higher optical transparency and has higher flexibility than optically transparent conductive materials including an ITO conductive film. In particular, the silver salt diffusion transfer method capable of forming metal thin wires with silver can reproduce uniform wire width, and can also provide high conductivity with a narrower wire width compared to other methods because silver has the highest conductivity of all metals.

The conductive metal thin wires per se are not optically transparent, but the metal mesh material exhibits optical transparency and conductivity because the metal thin wires are arranged in a net-like pattern. Known net-like patterns include ones in which polygons such as quadrangles and octagons described in, for example, Patent Literature 1 and Patent Literature 2, and other known regular shapes such as circles and ellipses are used as unit figures, and such unit figures are repeated to form net-like patterns. In another known example, a particular regular shape described in Patent Literature 3 or the like is used as a unit figure, and such unit figures are repeated to form a net-like pattern.

In the case where the metal mesh material is used in devices such as a projective capacitive touchscreen having a circuit pattern in an optically transparent conductive layer, usually, disconnection parts are provided in the net-like pattern of metal thin wires to divide the conductive portion so as to provide multiple circuits (sensor parts) in one sheet. In such usage, a net-like pattern of metal thin wires formed of the regular shape described above as a unit figure is generally advantageous in that the net-like pattern is easily applicable to a narrow circuit pattern; however, moire easily occurs in the case where such a net-like pattern is overlapped on a structure having a regular pattern as in the case of a liquid crystal display. In contrast, in the case where an irregular net-like pattern of metal thin wires is used, moire does not easily occur; however, in the case where such an irregular net-like pattern is applied to a narrow circuit pattern, it unfortunately increases the fluctuation in conductivity. Thus, such an irregular net-like pattern is not easily applicable. Therefore, net-like patterns formed of regular shapes and irregular net-like patterns have been used differently depending on usage characteristics.

In the optically transparent conductive layer, generally, linear electrodes (linear electrodes in the form of a net-like pattern of metal thin wires) extending in a first direction and aligned in a direction perpendicular to the first direction are used as a circuit pattern. In order to increase the sensitivity of the sensor, the width of the linear electrode is very narrow in some optically transparent conductive layers. In such a case, a net-like pattern of metal thin wires formed of the regular shape described above as a unit figure is suitably used. In addition, conventional projected capacitive touchscreens that have been commonly used are double-layer capacitive touchscreens in which two optically transparent conductive layers including an ITO conductive film or a net-like pattern of metal thin wires are overlapped on each other. Yet, recently, single-layer capacitive touchscreens including an optically transparent conductive material that includes only a single optically transparent conductive layer have been proposed (for example, Patent Literature 4). In such single-layer capacitive touchscreens, optically transparent conductive layers are provided with a particular pattern to allow for detection of a position. These single-layer capacitive touchscreens have higher optical transparency than double-layer capacitive touchscreens because optically transparent conductive layers are not overlapped on each other as described above.

Some of the single-layer capacitive touchscreens, as described in Patent Literature 4, for example, have a structure in which an optical transparent region (301 in FIG. 3 of Patent Literature 4) contains sensor parts (304 in the same figure) for sensing the capacitance and optically transparent wiring parts (302 in the same figure) for transmitting changes in the capacitance sensed by the sensor parts to the outside. The optically transparent wiring parts are made narrow to minimize the area occupied by these parts and are arranged collectively away from the sensor parts. The optically transparent wiring parts are usually formed in relatively long straight lines or relatively long bent lines. If a single-layer capacitive touchscreen is produced using a metal mesh material, such optically transparent wiring parts formed in long lines will be noticeable due to their high visibility. Thus, as proposed by Patent Literature 3 described above, for example, the same net-like pattern of metal thin wires of the sensor parts is used to form the optically transparent wiring parts.

### CITATION LIST

### Patent Literatures

Patent Literature 1: JP-A 2002-223095
Patent Literature 2: JP-T 2012-519329
Patent Literature 3: JP-A 2014-241132
Patent Literature 4: JP-A 2011-181057

### SUMMARY

Touchscreens are generally overlapped on a rectangular display incorporating elements such as a black matrix, liquid crystal cells, and light-emitting cells. Usually, these elements are aligned in parallel or perpendicular to sides (sides of an outer frame) of the display. As described above, in a touchscreen having narrow linear electrodes (highly sensitive touchscreen), a net-like pattern of metal thin wires formed of a regular shape as a unit figure is preferably used; however, moire easily occurs when a regular shape is used as a unit figure. Moire is an unintended pattern that is visible when multiple periodic patterns are overlapped on each other. It is a phenomenon long known particularly in the color printing field and the like in which periodic patterns with halftone dots are used by being overlapped on each other, and the occurrence of moire is a problem because it degrades appearance. The occurrence mechanism of moire and its remediation measures are described, for example, in “Hyojun DTP Shutsuryoku Koza (Standard DTP Output Seminar) (Shoeisha Co., Ltd., published on Sep. 30, 1997)”, p. 138. Moire generated by a net-like pattern of metal thin wires and elements of a display has two types: angular moire that occurs because the angular difference is small between the angle of alignment of the elements of the display (which corresponds to the direction of a side of the display and it is hereinafter referred to as “X direction” or “Y direction”) and the angle of a side of the unit figures formed of metal thin wires; and periodic moire that occurs because the difference is small between the repetition period of the elements in the X and Y directions and the repetition period of the unit figure in the pattern of metal thin wires in the same respective directions (i.e., the widths of the unit figure in the X and Y directions). Thus, when selecting a regular shape as the unit figure, it is necessary to select a regular shape whose widths in the X and Y directions do not overlap with the periods of the elements of the display in the X and Y directions, and the angle of a side of the unit figure formed of metal thin wires is not close to the X and Y directions.

In addition, as described above, narrowing the width of a linear electrode to increase the sensitivity of a double-layer capacitive touchscreen requires narrowing the width of the unit figure in the width direction of the linear electrode. Otherwise, a necessary number of unit figures to ensure conductivity would not fit in such a narrow linear electrode. If the width of a unit figure is wide in the width direction of the linear electrode, unfortunately, fewer unit figures will fit in the linear electrode in the width direction and the resistance of the linear electrode will increase, which conversely may reduce the sensitivity or cause disconnection in the linear electrode. In addition, when the width of the unit figure is made narrow in the width direction of the linear electrode, the width of the unit figure needs to be increased in the direction in which the linear electrode extends. Otherwise, the optical transparency would be reduced. In the case where the width of the unit figure is increased in the direction in which the linear electrode extends in order to prevent a reduction in optical transparency, the angle of a side forming the unit figure becomes closer to either the X or Y direction. Consequently, angular moire tends to occur easily. As described here, there is a demand for an optically transparent conductive material including a metal mesh material which can suppress the occurrence of moire when used in a capacitive touchscreen having narrow linear electrodes and which can reduce the resistance of the linear electrodes.

Further, as described above, single-layer capacitive touchscreens have optically transparent wiring parts in the form of relatively long straight lines or relatively long bent lines in an optical transparent region (in an active area of the display). The optically transparent wiring parts do not function as sensors, so that it is desirable to minimize the area occupied by these parts. Thus, a unit figure with which the area occupied by the optically transparent wiring parts is minimized is suitably selected. However, conventionally known general methods can reduce the area occupied by these optically transparent wiring parts only to a limited extent, as explained below.

FIG. 1 is a view that explains problems of conventional techniques. In FIG. 1, a-1 shows an optically transparent wiring part 31 in which solid wires (wires having a wide solid pattern) are placed collectively in the case where an optically transparent conductive layer, such as an ITO conductive film, is used. This optically transparent wiring part consists of a wiring part 01 and a non-wiring part 02. As specific examples of a-1, structures formed with common net-like patterns of metal thin wires are shown in a-2 to a-7. As a characteristic of a pattern of metal thin wires, in a part where an electric current flows (the wiring part 01 in a-1), unit figures (such as rhombus) in a pattern of metal thin wires are made continuous with one another to provide an optically transparent wiring part. If a part where an electric current does not flow (the non-wiring part 02 in a-1) has no pattern, it creates a visibility problem that the boundary between the wiring part 01 and the non-wiring part 02 is visible. Thus, generally, a pattern of metal thin wires including a disconnection part is also provided in the non-wiring part 02 to reduce the appearance difference between the wiring part 01 and the non-wiring part 02 so as to solve the visibility problem, and conduction is cut off between the wiring part 01 and the non-wiring part 02, or a measure is taken to prevent a short circuit between wires. In a-2 to a-7 of FIG. 1, dashed lines schematically show a pattern of metal thin wires including a disconnection part for the above purpose, and solid lines schematically show a pattern of metal thin wires without a disconnection part.

a-2 shows an optically transparent wiring part in which the wiring part 01 is formed of multiple rhombuses 3 in a pattern of metal thin wires, and the non-wiring part 02 is formed of multiple rhombuses 4 in a pattern of metal thin wires including a disconnection part (such a pattern is referred to as a dummy part). In this example, the visibility problem that the optically transparent wiring part 31 is visible is solved by the presence of the rhombuses 4. Meanwhile, as described above, there is a demand to minimize the area occupied by the optically transparent wiring part 31, which requires to narrow the widths of the wiring part 01 and the non-wiring part 02. Examples of methods for narrowing the width of the wiring part 01 include one in which the unit figure is replaced with a shape similar to the unit figure but smaller than the unit figure, and one in which the width of the unit figure in the x direction in FIG. 1 is made narrow. In the former case, unfortunately, the optical transparency is reduced. In the latter case, the angle of a side of the unit figure becomes closer to the y direction in FIG. 1. When such a pattern is overlapped on a liquid crystal display, unfortunately, moire will occur between this pattern and a black matrix having a pattern in both X and Y directions (usually, these directions correspond to the x direction and the y direction in FIG. 1).

a-3 shows an example in which the area occupied by the optically transparent wiring part is reduced in the following manner in order to maintain optical transparency: the unit figure is the same as that in a-2 but a disconnection position is changed; and a width 37 of the wiring part 01 is the same as a repetition period 35 of the unit figure in the x direction but a width 36 of the non-wiring part 02 is made narrow. In a-3, a wiring part 311, which is one of the wiring parts 01, is formed of continuous rhombuses in a pattern of metal thin wires without a disconnection part, and thus, the wiring part 311 continuously extends in the y direction with a pattern of two conducting metal thin wires. In contrast, a wiring part 312, which is located two columns away from the wiring part 311 and which is another one of the wiring parts 01, has a pattern of metal thin wires formed of continuous rhombus figures but rhombuses partially include disconnection parts. Thus, the wiring part 312 continuously extends in the y direction with a pattern of only one conducting metal thin wire. Thus, since the wiring part 311 has different conductivity from the wiring part 312, the use of the optically transparent wiring part in a-3 unfortunately causes malfunction of a touch sensor. a-4 shows an example in which the width 36 of the non-wiring part 02 is made narrow but the width 37 of the wiring part 01 is made wide to allow every wiring part 01 to be connected in the y direction with a pattern of two conducting metal thin wires. Yet, the area occupied by the optically transparent wiring part 31 is not reduced, despite the number of the wiring parts 01, as compared to a-2. Moreover, since the wiring part 01 continuously extends in the y direction still with a pattern of only two metal thin wires, the conductivity of the optically transparent wiring part 31 is not improved, as compared to a-2. a-5 shows an example in which the width 36 of the non-wiring part 02 is made narrow, and at the same time, the width of the unit figure in the dummy part is also made narrow in the x direction. In this case, since the angle of a side of the unit figure formed of metal thin wires in the dummy part is small with respect to the y direction, moire easily occurs between this pattern and a black matrix.

Meanwhile, for example, doubling the size of a rhombus as the unit figure will increase the optical transparency of the optically transparent wiring part 31. This is shown in a-6. In a pattern of metal thin wires shown in a-6, the wiring part 01 and the non-wiring part 02 are formed of rhombuses 5 as the unit figures, formed of a metal thin wire (solid line) without a disconnection part and a metal thin wire (dashed line) with a disconnection part, respectively. Clearly, the optically transparent wiring part 31 in a-6 has higher optical transparency than the optically transparent wiring part 31 in a-2. However, in a-6, since the wiring part 01 is formed of only one metal thin wire, if disconnection occurs in the wiring part 01 due to trouble during the production, the production percentage of good touch sensors, i.e., yield, will significantly decrease, resulting in low production reliability. In the pattern of metal thin wires in a-2, even if a minor disconnection occurs, conduction will be maintained by another metal thin wire that is not disconnected as long as disconnection does not occur at an intersection between one rhombus 3 and its adjacent rhombus 3. Thus, the production reliability is significantly higher with the optically transparent wiring part 31 in a-2 than with that in a-6.

In a-7, a pattern of a metal thin wire 6 is arranged only at the outline of each wiring part 01 in a-1 to increase the optical transmittance. However, in such a case, the metal pattern will interfere with a black matrix of a liquid crystal display, which will cause moire.

One or more embodiments of the present invention provide an optically transparent conductive material with excellent production reliability, in which moire does not easily occur even when the optically transparent conductive material is overlapped on a display and which has high optical transparency and high conductivity. One or more embodiments of the present invention also provide an optically transparent conductive material in which the area occupied by the optically transparent wiring part in the optical transparent region can be reduced when the optically transparent conductive material is used in a single-layer capacitive touchscreen.

One or more embodiments of the present invention may be achieved by an optically transparent conductive material including an optically transparent support and a pattern of metal thin wires of repeated unit figures formed on the optically transparent support, wherein each of the unit figures is a combination of a main cell and a satellite cell, the number of cells sharing a side and/or a vertex with and adjacent to the main cell is larger than the number of cells sharing a side and/or a vertex with and adjacent to the satellite cell, and the longest distance between two arbitrarily selected points on the metal thin wires forming the main cell is longer than the width of the main cell in a direction perpendicular to the direction between the two points.

Here, preferably, the main cell and the satellite cell are each a figure that begins and ends at the same point, the point being one arbitrarily selected point on a side forming the figure (this is referred to as a “closed” figure), and the main cell and the satellite cell are each a figure that is no longer a “closed” figure once the figure is further divided.

Preferably, the cells sharing a side and/or a vertex with and adjacent to the main cell and the cells sharing a side and/or a vertex with and adjacent to the satellite cell are each a “closed” figure, and these cells are each a figure that is no longer a “closed” figure once the figure is divided.

Preferably, the pattern of metal thin wires includes a region as a sensor part, wherein the sensor part is formed of linear electrodes aligned in one direction, each linear electrode being a strip-like conductive region extending in a direction perpendicular to the one direction, and the unit figures in the pattern of metal thin wires forming the sensor part are repeatedly aligned in the direction in which the linear electrodes extend and the direction in which the linear electrodes are aligned.

Preferably, at least three unit figures are repeatedly aligned in the direction in which the linear electrodes of the sensor part are aligned, at a narrowest portion of the strip-like conductive region formed of the linear electrodes in the direction in which the linear electrodes of the sensor part are aligned.

Preferably, the main cell has a rhombus shape.

One or more embodiments of the present invention provide an optically transparent conductive material with excellent production reliability, in which moire does not easily occur even when the optically transparent conductive material is overlapped on a display and which has high optical transparency and high conductivity. In addition, one or more embodiments of the present invention provide an optically transparent conductive material in which the area occupied by the optically transparent wiring part in the optical transparent region can be reduced when the optically transparent conductive material is used in a single-layer capacitive touchscreen.

15

### BRIEF DESCRIPTION OF DRAWINGS

FIG. 1 is a view that illustrates conventional techniques.

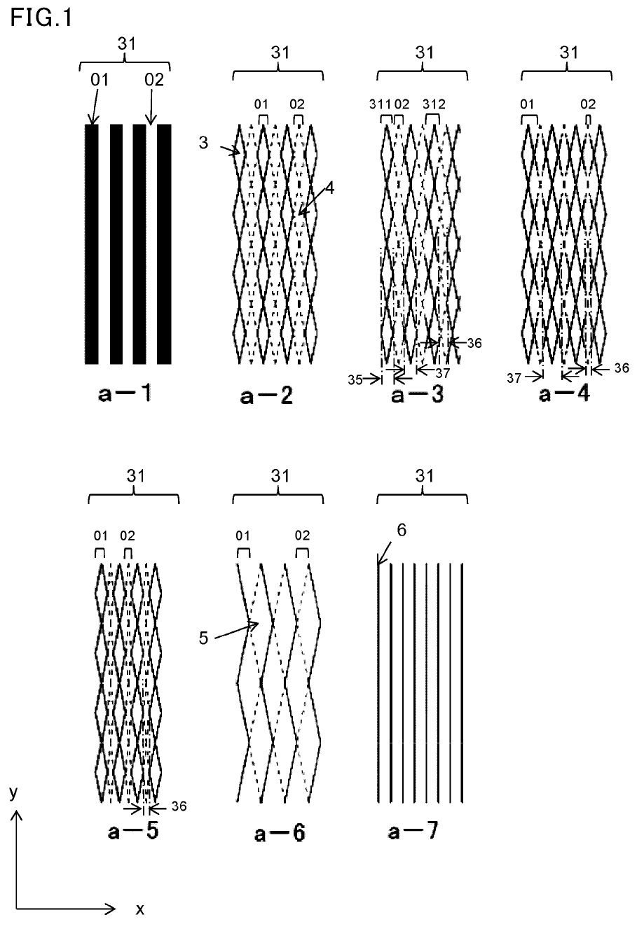

FIG. 2 is a schematic view of an example of an optically transparent conductive material according to one or more embodiments of the present invention.

FIG. 3 is a schematic view of another example of the optically transparent conductive material according to one or more embodiments of the present invention.

FIG. 4 is a view that explains a unit figure.

FIG. 5 is a view that explains a main cell and a satellite cell.

FIG. 6 is a schematic view of a net-like pattern of metal thin wires with different unit figures.

FIG. 7 is a schematic view of a net-like pattern of metal thin wires with different unit figures.

FIG. 8 is a schematic view of a net-like pattern of metal thin wires with different unit figures.

FIG. 9 is a schematic view of a net-like pattern of metal thin wires with different unit figures.

FIG. 10 is a schematic view of a net-like pattern of metal thin wires with different unit figures.

FIG. 11 is a view that illustrates the width of a main cell.

FIG. 12 is a view that illustrates comparisons of conventional techniques with one or more embodiments of the present invention.

FIG. 13 is a view that illustrates comparisons of conventional techniques with one or more embodiments of the present invention.

### DESCRIPTION OF EMBODIMENTS

One or more embodiments of the present invention is described in detail below with reference to the drawings, but the present invention is not limited to the following embodiments, and various changes and modifications may be made without departing from the technical scope of the invention.

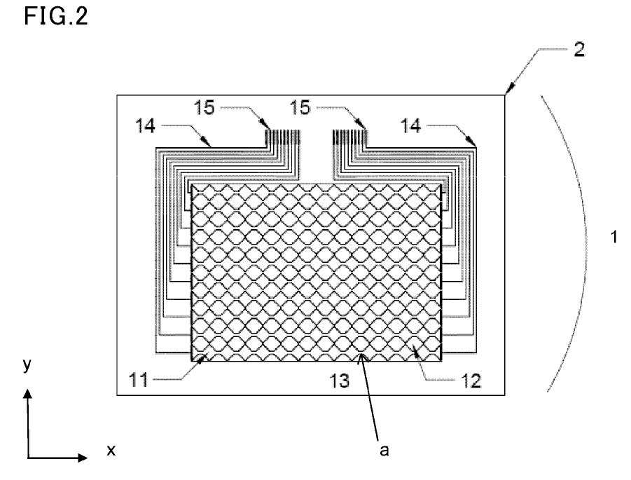

FIG. 2 is a schematic view of an example of an optically transparent conductive material. In FIG. 2, an optically transparent conductive material 1 includes an optically transparent support 2 on which provided are a sensor part 11 formed in a pattern of metal thin wires in which unit figures are repeated, and a dummy part 12 formed in a pattern of metal thin wires in which unit figures are repeated and which includes a disconnection part at least at a boundary from the sensor part 11. The optically transparent conductive material 1 also includes, in addition to the sensor part 11 and the dummy part 12, a wiring part 14 and a terminal area 15 each formed in a metal pattern. The sensor part 11 is electrically connected to the terminal area 15 via the wiring part 14. As the sensor part 11 is electrically connected to the outside via the terminal area 15, changes in the capacitance sensed by the sensor part 11 can be captured. In contrast, the dummy part 12 is not electrically connected to the terminal area 15. The numerical symbol 13 denotes a non-image area where no metal pattern is present. In one or more embodiments of the present invention, the sensor part 11 and the dummy part 12 are each formed in a fine net-like pattern of metal thin wires. Yet, in FIG. 2, for the sake of convenience, the boundary between the region of the sensor part 11 and the region of the dummy part 12 is shown by an imaginary borderline a (although the sensor part 11 and the dummy part 12 are shown with no pattern, these parts each actually includes a pattern of metal thin wires, and disconnection parts are present along the imaginary borderline a). The optically transparent conductive material as shown in FIG. 2 is suitably used in a double-layer capacitive touchscreen by overlapping the optically transparent conductive material in which the sensor part 11 extends in one direction (in FIG. 2, in the x direction) on another same type of the optically transparent conductive material in which the sensor part 11 extends in a different direction.

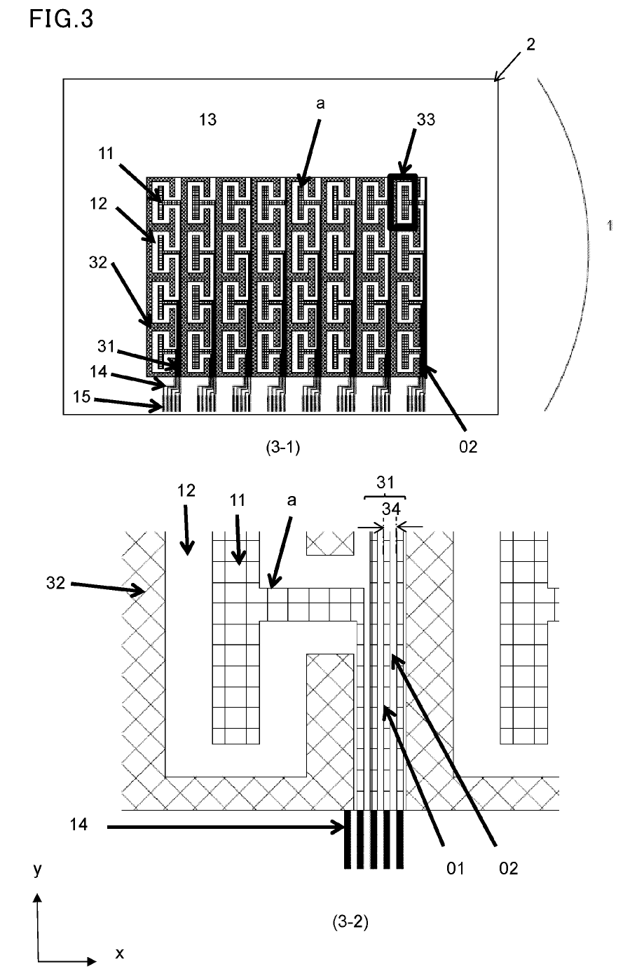

FIG. 3 is a schematic view of another example of the optically transparent conductive material. (3-1) is a general view, and (3-2) is an enlarged view of a portion of (3-1). In FIG. 3, the optically transparent conductive material 1 includes the optically transparent support 2 on which provided are the sensor part 11, the dummy part 12, the optically transparent wiring part 31, and a reference sensor part 32, each of which is formed in a pattern of metal thin wires of repeated unit figures. The optically transparent wiring part 31 includes the wiring part 01 and the non-wiring part 02. The dummy part 12 and the non-wiring part 02 include disconnection parts at least at a boundary from other region(s). Further, the optically transparent conductive material 1 in FIG. 3 may include, in addition to the regions described above, the wiring part 14 and the terminal area 15 which are formed of solid wires, or the non-image area 13 where no metal pattern is present. The sensor part 11 and the reference sensor part 32 are electrically connected to the terminal area 15 via the optically transparent wiring part 31 and the wiring part 14. As the sensor part 11 and the reference sensor part 32 are electrically connected to the outside via the terminal area 15, changes in the capacitance sensed by the sensor part 11 and the reference sensor part 32 can be captured. In contrast, the non-wiring part 02 and the dummy part 12 are not electrically connected to the terminal area 15. In FIG. 3, the boundary between the region of the sensor part 11 and the region of the dummy part 12 is shown by an imaginary borderline a (although the dummy part 12 is shown with no pattern, the dummy part 12 actually includes a pattern of metal thin wires with a disconnection part). The optically transparent conductive material as shown in FIG. 3 is suitably used in a single-layer capacitive touchscreen.

As described above, the sensor part 11 and the dummy part 12 in FIG. 2, or the sensor part 11, the dummy part 12, the optically transparent wiring part 31, and the reference sensor part 32 in FIG. 3 are each formed in a pattern of metal thin wires in which unit figures are repeated. The sensor part 11, the dummy part 12, the optically transparent wiring part 31, and the reference sensor part 32 may have the same unit figure or different unit figures. In addition, the unit figure may be different depending on the position in the optically transparent conductive material. Yet, preferably, all the parts are formed of the same unit figures. Preferably, the dummy part 12 and the non-wiring part 02 each include a disconnection part in the pattern of metal thin wires forming the inside of these regions, in addition to the disconnection part at least at a boundary from other region(s). In one or more embodiments of the present invention, the shape of each unit figure of the dummy part 12 and the non-wiring part 02 having a disconnection part is described, assuming that the disconnection part is connected.

The width of the metal thin wire in the pattern is preferably 20 μm or less, more preferably 1 to 15 μm, still more preferably 2 to 10 μm. The aperture ratio of the pattern (the ratio of the area occupied by portions without metal thin wires to the area occupied by parts such as the sensor part 11, the dummy part 12, the optically transparent wiring part 31, and the reference sensor part 32) is preferably 95% or more, still more preferably 96 to 98%. In addition, in the dummy part 12 and the non-wiring part 02, disconnection parts are provided to cut off conduction inside of these parts and between these parts and other regions. The length of each disconnection part (the length of a gap in the metal thin wire) is preferably 1 to 50 μm, more preferably 5 to 20 μm. Disconnection may be made by a known method such as forming a cut portion vertically or obliquely on the metal thin wire or the one suggested in JP-A 2014-127115, for example.

In one or more embodiments of the present invention, the term “unit figure” refers to a smallest figure that can form a whole pattern by repeatedly aligning only these unit figures (the “smallest” as the area of the unit figure including metal thin wires and a region surrounded by these metal thin wires). In addition, the term “repeatedly align” means to align the unit figures without overlapping on a plane surface such that these unit figures share a side and/or a vertex so as to form a regular net-like figure as a whole pattern. It should be noted that “two unit figures share a side and/or a vertex” means that one side or vertex is a side or vertex of one unit figure and, at the same time, is a side or vertex of another unit figure. In other words, when the unit figures are repeatedly aligned to form a whole pattern, the metal thin wires of the unit figures are overlapped on each other in the width direction at a side or vertex shared by these unit figures. Further, essentially, each of the unit figures consists of “closed” figures. Yet, in exceptional cases, the unit figure may include an “open” figure. However, such exceptional cases apply only when the unit figure cannot form a whole pattern without including an open figure. In one or more embodiments of the present invention, sides of the unit figure may be straight lines or curves. The “closed” figure refers to a figure that begins and ends at the same point, the point being one arbitrarily selected point on a side forming the figure. For example, shapes such as a circle, an ellipse, and a polygon are closed figures. In contrast, the “open” figure refers to a figure that is not closed. For example, a segment is an open figure.

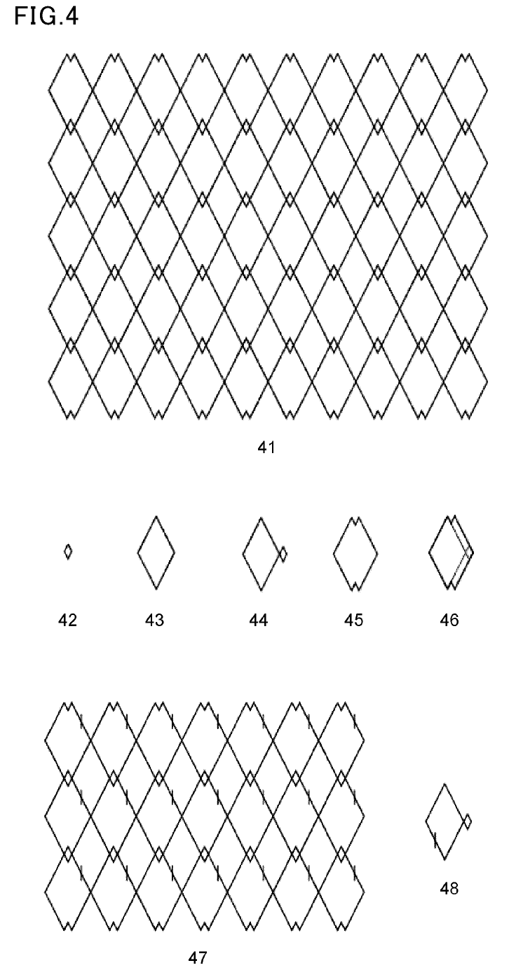

The above is described with reference to FIG. 4. In FIG. 4, a mesh 41 is a net-like pattern of metal thin wires for the optically transparent conductive material. Analysis of the mesh 41 shows that the mesh 41 is formed of “closed” figures, i.e., cells 42 to 45. The cell 42 and the cell 43 are cells that are no longer “closed” figures once they are further divided (hereinafter also referred to as “minimal closed cells”). Yet, each of these cells cannot independently form the mesh 41. Thus, these cells are herein not considered as the unit figures. The cell 44 and the cell 45 each can independently form the mesh 41. As described above, the unit figure is defined as the smallest figure. To compare the size between the cell 44 and the cell 45, the cell 44 and the cell 45 are overlapped on each other, as shown in a FIG. 46. As is clear from the FIG. 46, the cell 44 fits in the cell 45, and the area of the cell 44 is smaller than that of the cell 45. Thus, the unit figure of the mesh 41 is the cell 44. A mesh 47 is an example of a net-like pattern of metal thin wires formed of a unit FIG. 48 that exceptionally includes an “open” figure.

In the optically transparent conductive material according to one or more embodiments of the present invention, the unit figure is a combination of a main cell and a satellite cell. As described above, in the optically transparent conductive material, the unit figure is a combination of multiple minimal closed cells (for example, the unit FIG. 44 in FIG. 4 consists of the cell 42 and the cell 43), or a combination that exceptionally includes an “open” figure (for example, the unit FIG. 48 in FIG. 4 is a ternary combination of a large rhombus cell (a minimal closed cell), a small rhombus cell (a minimal closed cell), and exceptionally, an a segment (an “open” figure)). In one or more embodiments of the present invention, the main cell is one of the minimal closed cells forming the unit figure. In the net-like pattern of metal thin wires, when the number of cells sharing a side and/or a vertex with and adjacent to one minimal closed cell is larger than the number of cells sharing a side and/or a vertex with and adjacent to another minimal closed cell(s) forming the unit figure and when the number is also the largest, the one minimal closed cell is a main cell among the minimal closed cells forming the unit figure. The main cell and the satellite cell are preferably minimal closed cells. In addition, the cells sharing side and/or vertex with and adjacent to the main cell, and the cells sharing a side and/or a vertex with and adjacent to the satellite cell are also preferably minimal closed cells. In FIG. 4, the cell 45 is not either a main cell or a satellite cell because it does not form the cell 44 which is the unit figure.

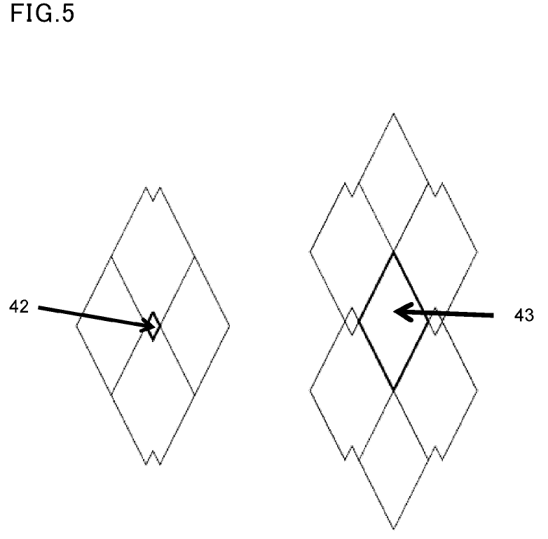

The above is described with reference to FIG. 5. FIG. 5 is a view that explains the main cell and the satellite cell. FIG. 5 shows the cell 42 and the cell 43 which are the minimal closed cells forming the unit FIG. 44 that form the net-like pattern of metal thin wires in FIG. 4. One diagram simply shows one cell 42 at the center and its surrounding adjacent cells. Another diagram simply shows one cell 43 at the center and its surrounding adjacent cells. In one or more embodiments of the present invention, the adjacent cells may be main cells, satellite cells, or any other cells. As is clear from FIG. 5, the number of cells sharing a side or vertex with the cell 42 is four. The number of cells sharing a side or vertex with the cell 43 is eight. Thus, the cell 43 is the “main cell” because the number of cells sharing a side and/or a vertex with and adjacent to the cell is larger than the number of cells sharing a side and/or a vertex with and adjacent to another minimal closed cell forming the unit figure, and the number is the largest. Such a main cell contributes the most to the conductivity. In one or more embodiments of the present invention, among the minimal closed cells forming the unit figure, all the minimal closed cells other than the main cells are regarded as satellite cells.

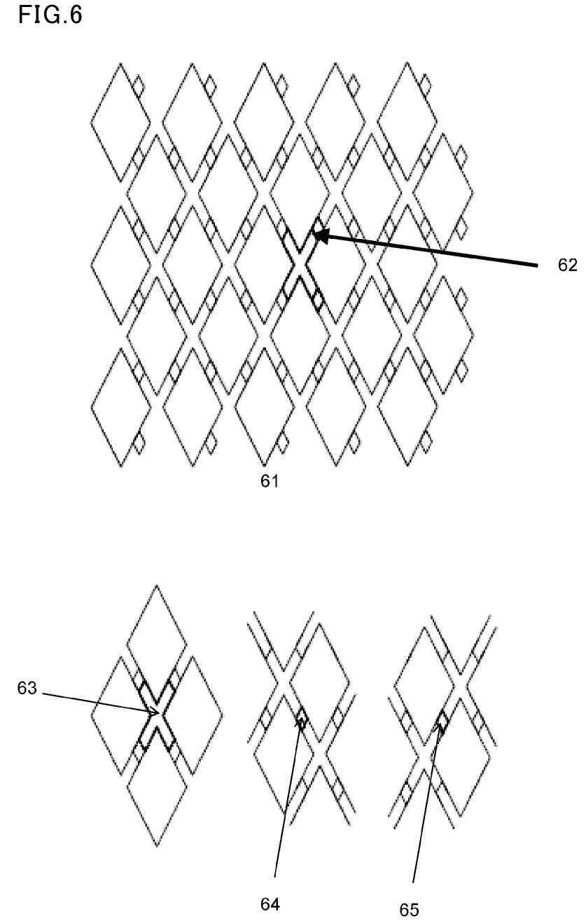

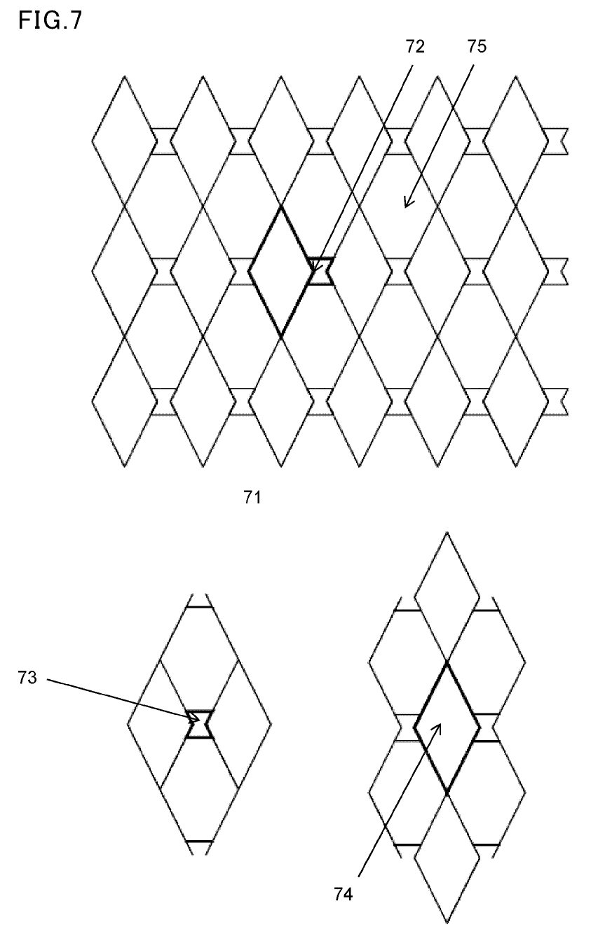

FIG. 6 is a schematic view of a net-like pattern of metal thin wires with different unit figures. In FIG. 6, a unit FIG. 62 (indicated by bold lines) forms a mesh 61, and the unit FIG. 62 consists of cells 63, 64, and 65. The number of cells sharing a side or vertex with the cell 63 is eight, the number cells sharing a side or vertex with the cell 64 is four, and the number of cells sharing a side or vertex with the cell 65 is four. Thus, the cell 63 is a main cell, and the cell 64 and the cell 65 are satellite cells. FIG. 7 is a schematic view of a net-like pattern of metal thin wires with different unit figures. In FIG. 7, a cell 74 has a smaller area than a cell 75. Thus, a unit FIG. 72 (indicated by bold lines) forming a mesh 71 includes cells 73 and 74. The number of cells sharing a side or vertex with the cell 73 is four, and the number of cells sharing a side or vertex with the cell 74 is eight. Thus, the cell 74 is a main cell, and the cell 73 is a satellite cell.

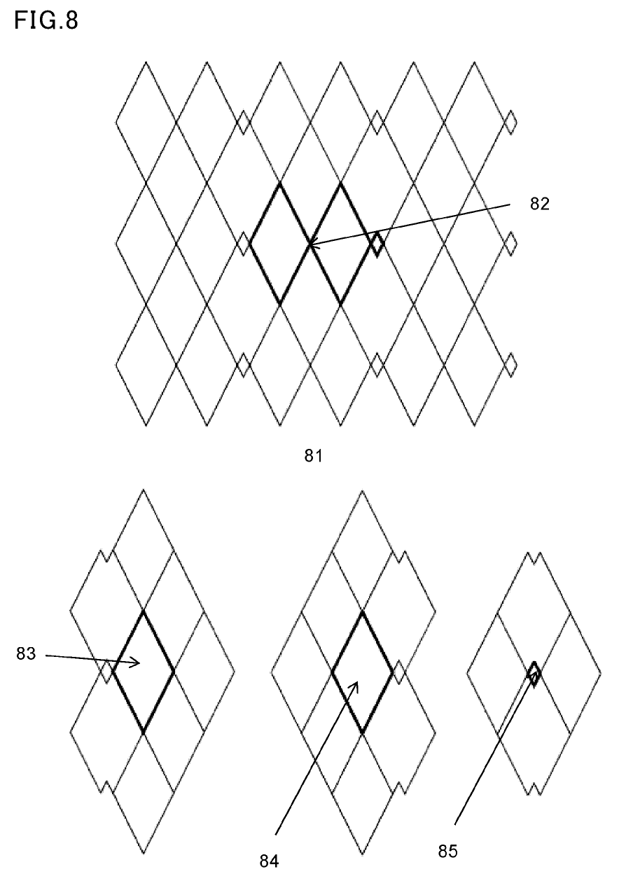

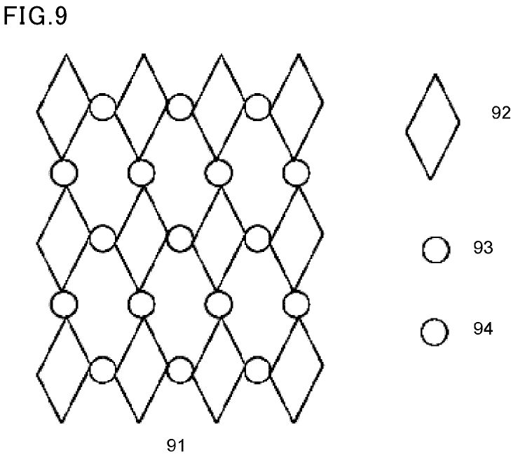

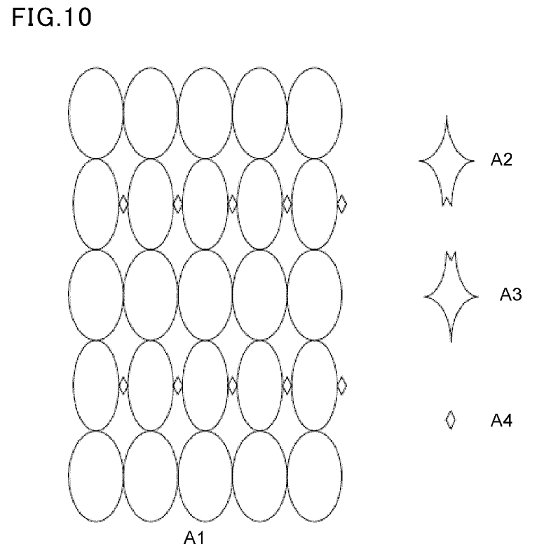

FIG. 8 is a schematic view of a net-like pattern of metal thin wires with different unit figures. In FIG. 8, a unit FIG. 82 (indicated by bold lines) forms a mesh 81, and the unit FIG. 82 consists of cells 83, 84, and 85. The number of cells sharing a side or vertex with the cell 83 is eight, the number of cells sharing a side or vertex with the cell 84 is eight, and the number of cells sharing a side or vertex with the cell 85 is four. Thus, the cell 83 and the cell 84 are both main cells. In this manner, the number of main cells does not have to be one. There may be two or more main cells. In addition, in FIG. 8, the figure of the main cell 83 is congruent to the figure of the main cell 84. These figures may be similar or different. In FIG. 9, a mesh 91 is formed of a unit figure which is a combination of a main cell 92 having a parallelogram shape, a satellite cell 93 having a circular shape, and a satellite cell 94 also having a circular shape like the satellite cell 93. In FIG. 10, a mesh Al is formed of a unit figure which is a combination of a main cell A2 having a shape obtained by cutting out a portion surrounded by ellipses and a rhombus, a main cell A3 having a similar shape as the main cell A2, and a satellite cell A4 having a rhombus shape.

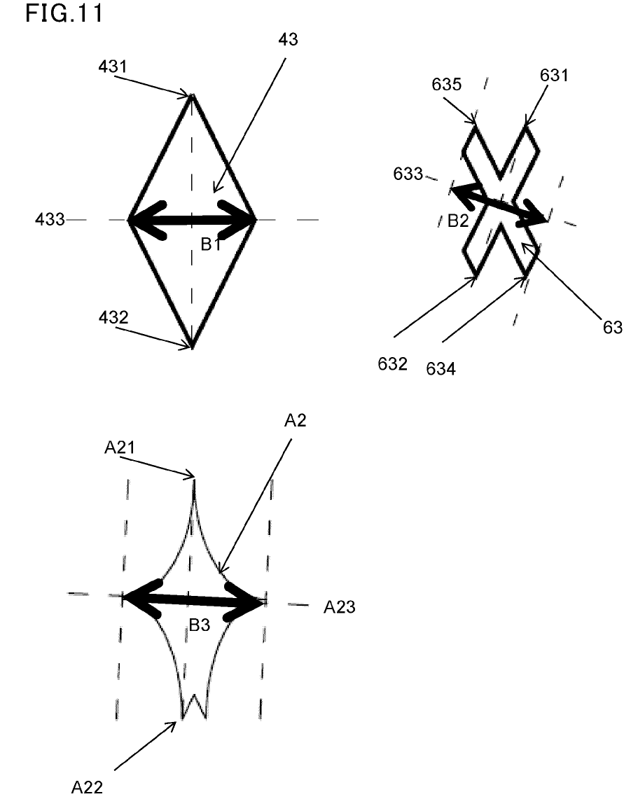

In the optically transparent conductive material, the unit figure has a shape in which the longest distance between two arbitrarily selected points on the metal thin wires forming the main cell is longer than the width of the main cell in a direction perpendicular to the direction between the two points. The above is described with reference to FIG. 11. FIG. 11 is a view that illustrates the width of a main cell. FIG. 11 shows the main cells 43, 63, and A2 shown in FIG. 4, FIG. 6, and FIG. 10, respectively.

Among arbitrarily selected pairs of points on the metal thin wires forming the main cell 43, a vertex 431 and a vertex 432 are two points whose distance is the longest. A line perpendicular to a segment 431-432 connecting these two points is a dotted line 433. The width of the main cell in the direction perpendicular to the direction in which the distance between two arbitrarily selected points on the metal thin wires forming the main cell is the longest corresponds to the distance between two segments whose distance is the longest among all the segments in parallel to the straight line connecting the two arbitrarily selected points and in contact with the main cell. Thus, the width of the main cell 43 in the direction of the dotted line 433 has a length indicated by a double-headed arrow B1. In one or more embodiments of the present invention, the segment 431-432 is longer than the double-headed arrow B1.

Next, the main cell 63 is described. There are multiple pairs of points whose distance is the longest among arbitrarily selected pairs of points on the metal thin wire forming the main cell 63. Here, for example, a vertex 631 and a vertex 632 are selected as two points whose distance is the longest. A line perpendicular to a segment 631-632 connecting these two points is a dotted line 633. The width of the main cell in the direction perpendicular to the direction in which the distance between two arbitrarily selected points on the metal thin wires forming the main cell is the longest corresponds to the distance between two segments whose distance is the longest among all the segments in parallel to the straight line connecting the two arbitrarily selected points and in contact with the main cell. Thus, the width of the main cell 63 in the direction of the dotted line 633 has a length indicated by a double-headed arrow B2. The segment 631-632 is longer than the double-headed arrow B2. In addition, a segment connecting a vertex 634 and a vertex 635 has the same length as the segment 631-632, and the width of the main cell 63 in the direction perpendicular to a segment 634-635 is shorter than the segment 634-635, as in the relationship between the segment 631-632 and the width of the main cell 63. As described above, in the case where there are multiple pairs of points whose distance is the longest among arbitrarily selected pairs of points on the metal thin wire forming the main cell, every pair of two points has a distance longer than the width of the main cell in the direction perpendicular to the direction between the two points.

Lastly, in the case of the main cell A2, there are multiple pairs of points whose distance is the longest among arbitrarily selected pairs of points on the metal thin wire forming the main cell A2. Here, for example, a vertex A21 and a vertex A22 are selected as two points whose distance is the longest. A line perpendicular to a segment A21-22 connecting these two points is a dotted line A23. The width of the main cell in the direction perpendicular to the direction in which the distance between two arbitrarily selected points on the metal thin wires forming the main cell is the longest corresponds to the distance between two segments whose distance is the longest among all the segments in parallel to the straight line connecting the two arbitrarily selected points and in contact with the main cell. Thus, the width of the main cell in the direction of the dotted line A23 has a length indicated by a double-headed arrow B3. The segment A21-A22 is longer than the double-headed arrow B3.

In the optically transparent conductive material, the shape of the main cell forming the unit figure is not particularly limited as long as the longest distance between two arbitrarily selected points on the metal thin wires forming the main cell is longer than the width of the main cell in the direction perpendicular to the direction between these two points. The main cell may have curved sides with no vertex (angle) on the sides. Examples of the shape of the main cell include triangles such as equilateral triangles, isosceles triangles, and right triangles; quadrangles (excluding squares) such as rectangles, parallelograms, trapezoids, and rhombuses; polygons such as hexagons, octagons (excluding regular octagons), dodecagons (excluding regular dodecagons), and icosagons (excluding regular icosagons); ellipses; star shapes; and combinations of these shapes. The main cell may have an indefinite shape as long as such main cells can be repeatedly aligned. Alternatively, the main cell may have a shape, such as the main cell 63 or the main cell A2, obtainable by cutting out after these figures are combined. As for the direction of a side of the cell, preferably, the side is tilted at an angle in the range of 23° to 67°, more preferably in the range of 25° to 65°, with respect to the direction in which the electrodes extend (x direction) or the direction in which the electrodes are aligned (y direction). In particular, rhombuses (excluding squares) that can suppress the occurrence of moire and can provide high conductivity, or figures obtainable by cutting out a figure obtainable with rhombuses (e.g., the main cell 63) are preferred.

In the optically transparent conductive material, unlike the main cell, the satellite cell has no limitation in the shape and can employ various shapes. The satellite cell may also have curved sides with no vertex (angle) on the sides. Examples of the shape of the satellite cell include knowns shapes, specifically, triangles such as equilateral triangles, isosceles triangles, and right triangles; quadrangles such as squares, rectangles, parallelograms, trapezoids, and rhombuses; polygons such as hexagons, octagons, dodecagons, and icosagons; ellipses; star shapes; and combinations of these figures. Alternatively, the satellite cell may have an indefinite shape or even a shape obtainable by cutting out a portion surrounded by the shapes described above as long as such satellite cells can be repeatedly aligned. Preferred shapes of the satellite cell are the same as those of the main cell. A shape similar to the main cell is more preferred because the occurrence of moire can be suppressed.

In the optically transparent conductive material, the unit figure may have a side (a side of the main cell and a side of the satellite cell) that is no not a straight line. For example, the side may be a zigzag line, a wavy line, or a curve. Yet, a straight line is preferred for maximizing the optical transparency and increasing the conductivity. Preferably, the unit figures are repeatedly aligned in the direction in which the electrodes are aligned (x direction) and the direction in which the electrodes extend (y direction) (i.e., when a specific position is selected in each unit figure and such specific positions in the unit figures repeatedly aligned are connected to form a straight line, it results in a straight line that extends in either the x direction or the y direction). Also, in the case where the direction in which the unit figures are aligned is deviated from the direction in which the electrodes are aligned and the direction in which the electrodes extend, the deviation is preferably in the range of ±5°.

In one or more embodiments of the present invention, metals, particularly gold, silver, copper, nickel, aluminium, and composite materials thereof, are preferably used to form the patterns of metal thin wires forming the sensor part 11 and the dummy part 12, and the metal patterns forming the wiring part 14, the terminal area 15, and the like. Examples of the method for forming the pattern of metal thin wires and the metal pattern using these metals (hereinafter may be simply collectively referred to as the “pattern”) include known methods such as a method in which a silver halide photosensitive material is used; a method in which a silver halide photosensitive material is used and an obtained silver image is electroless plated or electroplated; a method in which conductive ink such as silver paste or copper paste is printed by a screen printing method; a method in which conductive ink such as silver paste or copper paste is printed by an ink-jet method; a method in which a conductive layer is formed on a support by vapor deposition or sputtering, and a resistance film is formed thereon, followed by exposure, development, etching, and resist layer removal; and a method in which metal foil such as copper foil is attached, and a resistance film is formed thereon, followed by exposure, development, etching, and resist layer removal. Particularly preferred is the silver salt diffusion transfer method capable of making a thin pattern and also capable of easily forming a very fine pattern. If a pattern produced by any of these methods is too thick, it may be difficult to perform a post-process (such as adhering to other members). If a pattern is too thin, it may be difficult to provide necessary conductivity.

Thus, the thickness is preferably 0.01 to 5 μm, more preferably 0.05 to 1 μm. The optically transparent conductive material may have a pattern of metal thin wires either only one side or both sides of the optically transparent support. The silver salt diffusion transfer method is described in detail in JP-A 2003-77350, JP-A 2005-250169, JP-A 2007-188655, and the like.

The optically transparent support of the optically transparent conductive material is preferably a plastic, glass, rubber, or ceramic support, for example. Such an optically transparent support preferably has a total light transmittance of 60% or more. The plastic support is particularly preferably a flexible resin film because of its excellent handling properties. Specific examples of the resin film used as the optically transparent support include resin films made of polyester resin such as polyethylene terephthalate (PET) and polyethylene naphthalate (PEN), acrylic resin, epoxy resin, fluororesin, silicone resin, polycarbonate resin, diacetate resin, triacetate resin, polyarylate resin, polyvinyl chloride, polysulfone resin, polyether sulfone resin, polyimide resin, polyamide resin, polyolefin resin, and cyclic polyolefin resin, having a thickness of 50 to 300 μm. The optically transparent support may be provided with a known layer such as an easy-adhesion layer.

The optically transparent conductive material may include, in addition to the optically transparent support, easy-adhesion layer, and pattern of metal thin wires described above, a known layer such as a hard coat layer, an antireflection layer, an adhesive layer, or an antiglare layer between the optically transparent support and the pattern of metal thin wires, on the side of the optically transparent support on which the pattern of metal thin wires is not formed, or on the pattern of metal thin wires. An additional known layer such as a physical development nuclei layer or an adhesive layer may also be provided between the optically transparent support and the pattern of metal thin wires.

As described above, FIG. 2 is a schematic view of an optically transparent conductive material having a metal pattern, typically used in a double-layer capacitive touchscreen. The shapes of the regions of the sensor part and the dummy part 12 are shown with the imaginary borderline a. The sensor part 11 is formed of linear electrodes aligned in the y direction, each linear electrode being a strip-like conductive region extending in the x direction perpendicular to the y direction. The shape of the region of one linear electrode is what is commonly called a diamond type in which square regions each tilted at 45° relative to the x direction and the y direction are aligned in the x direction, and these square regions are connected to their adjacent square regions at their vertexes in the x direction, so that conductivity is provided from the wiring part 14 to its opposite wiring part 14. The linear electrodes of the sensor part 11 are typically aligned at a period of about 5 mm in the y direction in the case of a touchscreen of a size of 20 inches or so, although the period depends on the performance and setting of a controller IC used. In the region of one linear electrode, the width of a narrowest portion in the y direction is preferably 0.5 to 2 mm. Although not shown, there are other known patterns, in addition to the diamond type, such as a bar type in which the linear electrode has a simple rectangular shape and a modified bar type in which the dummy part 12 is provided in the rectangular linear electrode. When these types of linear electrodes are used in the sensor part 11, the width of a narrowest portion is preferably 0.5 to 5 mm. One or more embodiments of the present invention may be effective in a narrowest portion (the constricted portion of the diamond type in which the square regions are connected to each other) of the strip-like conductive region formed of the linear electrodes of the sensor part 11. Preferably, in this narrowest portion, at least two (preferably at least three) unit figures (each figure is a combination of a main cell and a satellite cell) in the net-like pattern of metal thin wires are repeatedly aligned in the y direction in FIG. 2 so as to prevent malfunction of the sensor part 11 as a whole due to disconnection or the like in the metal thin wires.

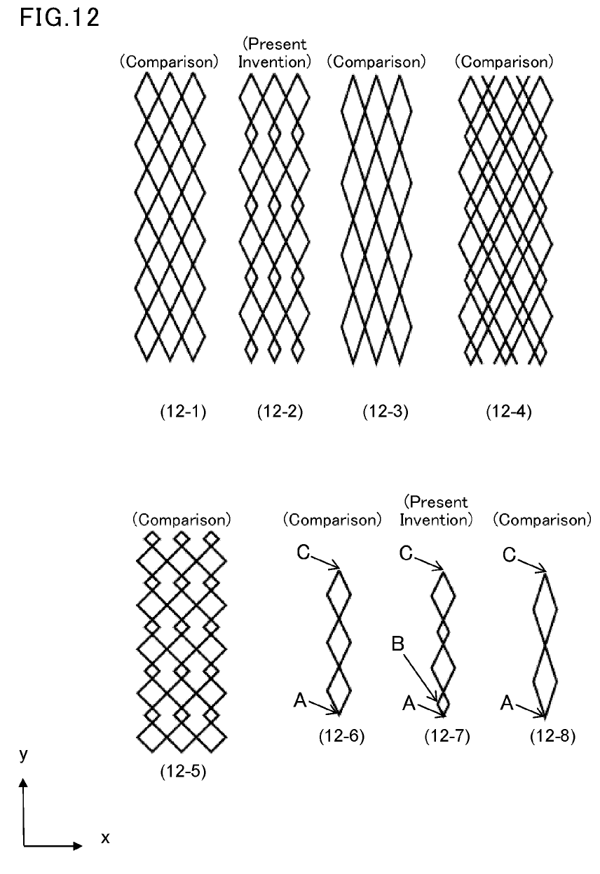

FIG. 12 is a view that illustrates a comparison of conventional techniques to one or more embodiments of the present invention as applied to the double-layer capacitive touchscreen shown in FIG. 2. FIG. 12 shows only a few unit figures aligned in an x direction, for the purpose of illustration. The x direction in FIG. 2 corresponds to a y direction in FIG. 12.

12-1 shows an optically transparent conductive material for comparison. It is a known net-like pattern of metal thin wires in which rhombus unit figures each having a major diagonal of 280 μm and a minor diagonal of 135 μm are aligned. In the case where the width of the metal thin wire is 3 μm, the aperture ratio is 95.11%. For example, in the case of a full HD standard 23-inch touchscreen, the pitch of the display elements is about 265 μm. The difference between the period of these elements and the period of the pattern of metal thin wires in the y direction, i.e., the length of the major diagonal of each rhombus, is only 15 μm. Thus, periodic moire easily occurs under such conditions. In contrast, the angle of the side of each rhombus in the pattern of metal thin wires with respect to the y direction is 25.7°. Thus, angular moire does not easily occur under such conditions. 12-2 shows the optically transparent conductive material in which the unit figure of 12-1 is a main cell and a similar rhombus whose side length is half the length of the main cell is a satellite cell. 12-2 has the same aperture ratio as 12-1. The period of the unit figures in the pattern of metal thin wires in the y direction is 420 μm (280 μm+140 μm). Thus, the occurrence of the periodic moire can be avoided under such conditions. 12-3 shows an optically transparent conductive material for comparison. It is a known net-like pattern of metal thin wires in which rhombuses each having a major diagonal of 420 μm and a minor diagonal of 135 μm are aligned. In 12-3, the angle of the side of each rhombus in the pattern of metal thin wires with respect to the y direction is 21.09°. Thus, angular moire easily occurs under such conditions. 12-4 is another optically transparent conductive material for comparison. The main cell and the satellite cell are the same rhombuses as those in 12-2, but these unit figures are arranged in a manner different from that in 12-2 to form a net-like pattern. Eight cells are adjacent to these rhombuses of both sizes, so that there is no distinction between the main cell and the satellite cell. Thus, this is not the optically transparent conductive material according to one or more embodiments of the present invention. In 12-4, as is the case with 12-2, the period of the unit figures in the pattern of metal thin wires in the y direction is 420 μm. Thus, the occurrence of periodic moire can be avoided under such conditions. The angle of the side of each rhombus in the pattern of metal thin wires with respect to the y direction exceeds 25°. Thus, angular moire does not occur under such conditions. In contrast, the aperture ratio is 93.5%, which is significantly poor as compared to 12-2. 12-5 shows another optically transparent conductive material for comparison. Square main cells and square satellite cells are combined to obtain the same aperture ratio as in 12-1 and 12-2. In 12-5, the period of the unit figures in the pattern of metal thin wires in the y direction is 257.2 μm. For example, in the case of the sensor part 11 in which the narrowest portion of the strip-like conductive region formed of the linear electrodes is 0.5 mm, three unit figures can be aligned in the y direction of FIG. 2 when any of the patterns of metal thin wires of 12-1 to 12-3 is used; however, only two unit figures can be aligned when the pattern of metal thin wires of 12-5 is used.

In FIG. 12, 12-6 shows the unit figures of 12-1 aligned in one column with three rows in the y direction. 12-7 shows the unit figures of 12-2 aligned in one column with two rows in the y direction. 12-8 shows the unit figures of 12-3 aligned in one column with two rows in the y direction. These are simplified drawings of 12-1 to 12-3 for calculating the probability of disconnection of the optically transparent conductive material having a pattern of metal thin wires. Provided that the probability of disconnection per unit length of the pattern of metal thin wires is constant and that the probability of disconnection between A and B in 12-7 is 5%, the probability of disconnection with no electrical connection between A-C in each of 12-6 to 12-8 is as follows as mathematically calculated: 0.748% in 12-6, 0.582% in 12-7, and 1.37% in 12-8. This shows that the probability of disconnection in the optically transparent conductive material is lower than that in conventional patterns. The above description clearly explains advantages of the use of the optically transparent conductive material according to one or more embodiments of the present invention in double-layer capacitive touchscreens.

As described above, FIG. 3 is a schematic view of a single-layer capacitive touchscreen. In FIG. 3, the shapes and sizes of the sensor part 11, the reference sensor part 32, and the dummy part 12 located between the sensor part 11 and the reference sensor part 32 vary depending on the performance and setting of a controller IC used. The period of a sensing unit 33 (a portion enclosed in a quadrangle in 3-1 of FIG. 3 is one of them) consisting of a pair of one sensor part 11 and one reference sensor part 32 in the x direction and the y direction also varies depending on the performance and setting of the controller IC, but it is usually about 3 to 10 mm. A pitch 34 (the sum of the width of one wiring part 01 and the width of one non-wiring part 02 located between the wiring part 01 and its adjacent wiring part 01) in the optically transparent wiring part 31 is usually about 100 to 300 μm. The width occupied by the optically transparent wiring part 31 is a product of multiplication of the pitch 34 and the number of the wiring parts 01.

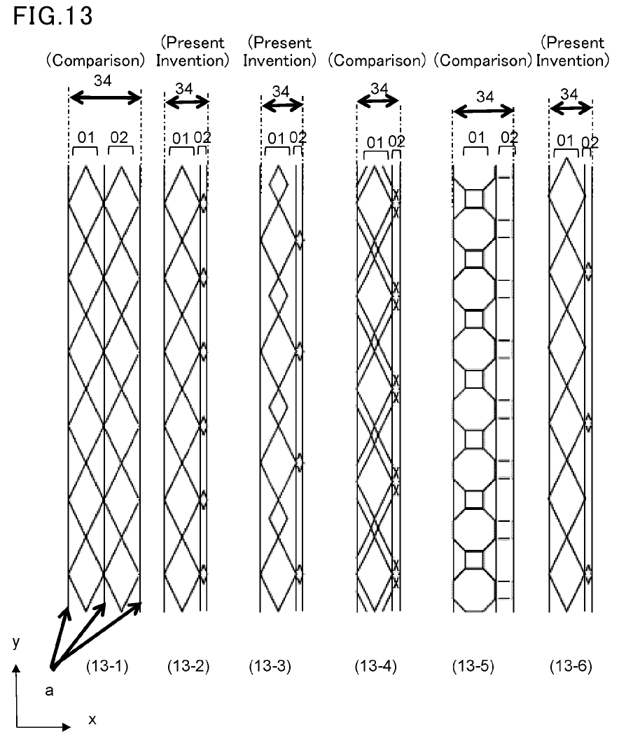

Advantages to be achieved by the application of one or more embodiments of the present invention in the single-layer capacitive touchscreen shown in FIG. 3 are described with reference to FIG. 13. FIG. 13 shows one pitch in the optically transparent wiring part 31 in FIG. 3. For the sake of explanation, the boundary between the wiring part 01 and the non-wiring part 02 is indicated by an imaginary borderline a, and a disconnection part is provided on the borderline a to cut off conduction between the wiring part 01 and the non-wiring part 02.

13-1 shows an optically transparent conductive material for comparison. It is a net-like pattern of metal thin wires in which rhombus unit figures each having a major diagonal of 280 μm and a minor diagonal of 135 μm are aligned. In this case, the pitch 34 is 270 μm. The angle of the side of the unit figures in the pattern of metal thin wires with respect to the y direction is 25.7° as in 12-1. Thus, angular moire does not occur.

13-2 shows the optically transparent conductive material according to one or more embodiments of the present invention. Here, the rhombus unit figure in 13-1 is a main cell, and a similar rhombus whose side length is ⅕ of the length of the main cell is a satellite cell. These satellite cells are arranged laterally (in the x direction) to the main cells. The angle of the side of the unit figures in the pattern of metal thin wires with respect to the y direction in 13-2 is the same as that in 13-1. Thus, angular moire does not occur. In this case, the pitch 34 is 162 μm. For example, the width of the optically transparent wiring part including 10 wiring parts 01 is 2.7 mm in 13-1 and 1.62 mm in 13-2. Thus, the width is very narrow. In other words, this shows that the area occupied by the wiring parts 01 and the non-wiring parts 02 can be reduced.

13-3 shows the optically transparent conductive material according to one or more embodiments of the present invention. Here, the rhombus unit figure in 13-1 is a main cell, and a similar rhombus whose side length is ½ of the length of the main cell is a satellite cell. These satellite cells are arranged between the main cells (in the y direction). 13-3 is highly preferred because a low disconnection probability can be expected for the same reason as explained for the disconnection probability with reference to FIG. 12. The angle of the side of the unit figures in the pattern of metal thin wires with respect to the y direction in 13-3 is the same as that in 13-2. Thus, angular moire does not occur.

13-4 shows an optically transparent conductive material for comparison. Here, the same rhombus unit figures used in 13-2 as the main cells and the satellite cells are arranged, and every rhombus is the same in terms of the number of its adjacent cells. In this case, the aperture ratio is low, which has been described with reference to FIG. 12. In addition to that, in the optically transparent conductive material having this pattern, the interconnection resistance per unit length of the optically transparent wiring part is exactly the same as that in 13-1 to 13-3. Thus, 13-4 is not superior in conductivity.

13-5 shows an optically transparent conductive material for comparison. Here, a square whose side is 66.57 μm and a regular octagon whose side is 66.57 μm are arranged in combination. The aperture ratio is 95.11% as in 13-2. In 13-5, the pitch 34 is 227.28 μm, which is significantly large. In addition to that, some sides have angles of 0° with respect to the x direction and the y direction. Thus, angular moire occurs.

In 13-6, among the satellite cells in 13-3, the similar rhombuses whose side length is ½ of the length of the main cell are replaced by similar rhombuses whose side length is 1.04 times the length of the main cell. This is the optically transparent conductive material according to one or more embodiments of the present invention. In 13-6, the pitch 34 can be adjusted to 162 μm as in 13-3 by modifying the shape of the disconnection part. Thus, for the same reason as in 13-2, angular moire does not occur. In addition, for the same reason as in 13-3, a low disconnection probability can be expected. Thus, 13-6 is highly preferred. The above description clearly explains advantages of the use of the optically transparent conductive material in single-layer capacitive touchscreens.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

### REFERENCE SIGNS LIST

1 optically transparent conductive material
2 optically transparent support
3, 4, 5 rhombus
6 pattern of metal thin wires
01, 14, 311, 312 wiring part
02 non-wiring part
11 sensor part
12 dummy part
13 non-image area
15 terminal area
31 optically transparent wiring part
32 reference sensor part
33 sensing unit
34 pitch
35 period of unit figures in x direction
36 width of dummy part in x direction
37 width of wiring part in x direction
41, 47, 61, 71, 81, 91, A1 mesh
42, 43, 44, 45, 46, 48, 62, 63, 64, 65, 72, 73, 74, 82, 83,
84, 85, 92, 93, 94, A2, A3, A4 cell
431, 432, 631, 632, 634, 635, A21, A22 vertex
433, 633, A23 dotted line
B1, B2, B3 width of main cell
a imaginary borderline

1. An optically transparent conductive material, comprising:
an optically transparent support; and
a pattern of metal thin wires of repeated unit figures formed on the optically transparent support,
wherein each of the unit figures is a combination of a main cell and a satellite cell,
the number of cells sharing a side and/or a vertex with and adjacent to the main cell is larger than the number of cells sharing a side and/or a vertex with and adjacent to the satellite cell, and
the longest distance between two arbitrarily selected points on the metal thin wires forming the main cell is longer than the width of the main cell in a direction perpendicular to the direction between the two points.

2. The optically transparent conductive material according to claim 1,
wherein the main cell and the satellite cell are each a closed figure that begins and ends at the same point, the point being one arbitrarily selected point on a side forming the figure, and
the main cell and the satellite cell are each a figure that is no longer a closed figure once the figure is further divided.

3. The optically transparent conductive material according to claim 1,
wherein the cells sharing a side and/or a vertex with and adjacent to the main cell and the cells sharing a side and/or a vertex with and adjacent to the satellite cell are each a closed figure that begins and ends at the same point, the point being one arbitrarily selected point on a side forming the figure, and
these cells are each a figure that is no longer a closed figure once the figure is divided.

4. The optically transparent conductive material according to claim 1,
wherein the pattern of metal thin wires comprises a region as a sensor part,
the sensor part is formed of linear electrodes aligned in one direction, each linear electrode being a strip-like conductive region extending in a direction perpendicular to the one direction, and
the unit figures in the pattern of metal thin wires forming the sensor part are repeatedly aligned in the direction in which the linear electrodes extend and the direction in which the linear electrodes are aligned.

5. The optically transparent conductive material according to claim 4,
wherein at least three unit figures are repeatedly aligned in the direction in which the linear electrodes of the sensor part are aligned, at a narrowest portion of the strip-like conductive region formed of the linear electrodes in the direction in which the linear electrodes of the sensor part are aligned.

6. The optically transparent conductive material according to claim 1,
wherein the main cell has a rhombus shape.
